(19) United States
(12) Patent Application Publication
(10) Pub. No.: US 2002/0030181 A1
(43) Pub. Date: Mar. 14, 2002

(54) Chemical solvent for opaque coatings on scratch-off game tickets

(76) Inventor: Eric M. Stroud, Oak Ridge, NJ (US)

Correspondence Address: Eric M. Stroud, 146 Notch Road, Oak Ridge, NJ, 07438, US

(21) Appl. No.: 09/946,429

(22) Filed: Sep. 5, 2001

Related U.S. Application Data
(60) Provisional application No. 60/231,748, filed on Sep. 11, 2000.

(51) Int. Cl. B01F 1/00

(52) U.S. Cl. 252/364

(57) ABSTRACT

A chemical solvent is provided which removes the opaque scratch-off coating on lottery and game tickets but not the printed indicia beneath the opaque coating. The chemical solvent utilizes at least one glycol ether or at least one polar organic solvent. The glycol ether consists of a total of at least three carbon atoms. The polar organic solvent consists of a total between one and nine carbon atoms. Diethylene glycol monoethyl ether, mesityl oxide, and ketene diethyl acetal are particularly effective. Polar organic solvents containing a carbonyl, carbon-carbon double bond, carbon-hydroxyl, or carboxylic acid function effectively dissolve the opaque scratch-off coating, such as mesityl oxide. Combinations of polar organic solvents and glycol ethers are also effective for dissolving the opaque scratch-off coating but not the printed indicia beneath the opaque coating.

### CROSS REFERENCE TO RELATED APPLICATIONS

This application claims the filing benefit under 35 U.S.C. §119(e) of U.S. Provisional Application No. 60/231,748, filed Sep. 11, 2000, included herein by reference.

### FIELD OF THE INVENTION

This invention relates to gambling generally, and more specifically the invention relates to scratch-off lottery tickets and scratch-off game tickets. Still more specific, the invention relates to a chemical solvent which can dissolve the opaque coating but not the printed indicia of a scratch-off lottery ticket or game ticket.

### BACKGROUND OF THE INVENTION

Many lottery tickets and game tickets include a backing of cardboard or other rigid stock material, printed indicia thereupon, and an opaque coating over some or all of the indicia. To remove the opaque coating, one must have an object with a sharp edge. Coins are sometimes used, but these have a rounded edge and are most unsatisfactory because of the extremely small contact area. Pocket knives are sometimes used, but these tend to cut through the ticket and destroy it. Nail files, credit card edges, razor blades and virtually every other conceivable kind of device with a sharp edge is used to scrape the opaque covering of the lottery ticket. Most or all of these methods are only moderately satisfactory. One great hazard of most of these methods lies in the fact that in some kinds of lottery tickets, if the number of the ticket, which is covered by the opaque covering, is disclosed by removing the opaque covering in that area, the lottery or game ticket is valid.

The present invention solves this dilemma and frees society from the risk of destroying the validity of the lottery or game ticket and provides a simple, efficient and effective means for removing the opaque coating from scratch-off lottery or game tickets.

### SUMMARY OF THE INVENTION

The present invention is comprised of a chemical solvent which has the properties necessary to remove the opaque coating from portions of a lottery ticket or game ticket, but not the printed indicia beneath the opaque coating.

Opaque coatings used on scratch-off lottery or game tickets can be dissolved utilizing many types of strong organic solvents, yet care must be taken not to remove the printed indicia beneath the coating, nor weaken the overall lottery ticket's rigidity. Many strong organic solvents, such as acetone, tetrahydrofuran, methanol, and cyclohexane all dissolve the scratch-off coating of a lottery or game ticket, but also effectively dissolve the ink printed beneath the scratch-off coating. Many of these solvents are extremely flammable. When diluted with water, some powerful organic solvents still present considerable toxicity risks and weaken the paper or cardboard substrate of the lottery or game ticket. The present invention utilizes a safer solvent which is primarily comprised of a glycol ether. The glycol ether can be chosen from among many forms for the best safety properties. Additional polar solvents may be combined in smaller amounts with the glycol ether to enhance efficacy. Polar solvent molecules contain double bond substitutions, hydroxyl functions, ether linkages, or esters. The solvent's rheology may be modified with thickening agents. The solvent may also be diluted with water or denaturants to reduce the overall solvency potency.

Glycol ethers are very suitable for use in removing scratch-off coatings and preserving print indicia. Glycol ethers are extremely good solvents having a bifunctional nature (ether-alcohol). Due to the miscibility with both polar and non-polar substances they are often used as coupling agents in, for example, water-based paints. A general structure for a glycol ether is R—(OCH2CH2)n-OR′, where: n=1, 2, or 3; R=alkyl C1-C7, phenyl, or alkyl substituted phenyl; R′═H or alkyl C1-C7; or OR′ consists of carboxylic acid ester, sulfate, phosphate, nitrate, or sulfonate.

Glycol ether acetates are one example of a carboxylic acid ester group in the —OR′ function stated above. These are clear liquids that often have a pleasant, fruity odor. They have a good solvent power but not as good as ketones. The viscosity cutting power is also less than ketones.

One particular glycol ether compound which is safe and effective for opaque scratch-off coating removal is diethylene glycol monoethyl ether. This solvent is also known as ethoxydiglycol, “Ektasolve DE”, or 2-(2-ethoxyethoxy)ethanol. This compound is based upon diethylene glycol. This molecule conforms to previous structure where R═(C2H5), n=2, and R′═(H), thus the overall structure is [C2H5]—[O]—[C2H4]—[O]—[C2H4]—[OH]. Ethoxydiglycol exhibits low toxicity in humans, reduced flammability from short chain alcohols, and excellent solvent properties.

A carboxylic acid function may accompany a glycol ether compound to provide a polar solvent with excellent solvent power. The carboxylic acid function is typically represented by —(C═O)—OH, where the hydroxyl (—OH) and carbonyl (═O) are covalently bonded to the carbon, producing the acid group. Glycol ethers and their carboxylic acid esters which are structurally similar to diethylene glycol monoethyl ether, and thus, are excellent for scratch-off coating removal include: ethylene glycol monomethyl ether (2-methoxyethanol); ethylene glycol monomethyl ether acetate (2-methoxy ethyl acetate); ethylene glycol monoethyl ether (2-ethoxyethanol); ethylene glycol monoethyl ether acetate (2-ethoxyethyl acetate); ethylene glycol monopropyl ether (2-propoxyethanol); ethylene glycol monobutyl ether (2-butoxyethanol); ethylene glycol dimethyl ether (1,2dimethoxy ethane);ethylene glycol diethyl ether (1,2-di ethoxyethane); diethylene glycol monomethyl ether (2-(2-methoxyethoxy)ethanol); diethylene glycol monobutyl ether (2-(2-butoxyethoxy)ethanol); diethylene glycol dimethyl ether (bis(2-methoxyethyl)ether);triethylene glycol dimethyl ether; propylene glycol monomethyl ether (1-methoxy-2-propanol); propylene glycol monomethyl ether acetate; dipropylene glycol; and dipropylene glycol monomethyl ether.

Polar organic solvents containing a hydroxyl function bonded to a carbon atom are also suitable for use in removing scratch-off coatings and preserving printed indicia. Theses compounds are typically called alcohols. Alcohols are versatile solvents with a pleasant odor. The length and the structure of the alkyl chain is decisive for the solvency of alcohols. Lower alcohols, between one and four carbon atoms, are water soluble and dissolve polar components. Care must be taken with short-chain alcohols, since they present toxicity and flammability risks. Short-chain alcohols are those alcohols which conform to the formula (R—OH), where R is an alkyl group consisting of six or fewer carbon atoms, and (—OH) is the functional hydroxyl group of the alcohol. The alkyl group corresponds to the structure (CnH(2n+1)), where there are (2n+1) hydrogen (H) atoms to every carbon atom (n) in the structure. The alkyl group may consist of a linear or “n-” chain of carbon atoms, such as n-propyl alcohol (C3H7OH), or a branched group of carbon atoms, in “iso” configurations, such as iso-propyl alcohol.

Polar organic solvents containing a carbonyl function, that is, an oxygen atom double bonded to a carbon atom, can successfully remove opaque scratch-off coatings. These compounds are called ketones and aldehydes. Ketones are water clear, highly mobile liquids having a characteristic odor. They are chemically very stable. Due to the carbonyl group, ketones are hydrogen acceptors and have an outstanding solvency. Ketones are potent, and care must be exercised because of toxicity and flammability risks. Short-chain ketone compounds conform to the structure (R1-(C═O)—R2), where R1 and R2 are alkyl chains conforming to (CnH2n+1) or substituted chains. These chains are covalently bonded to a keto function (C═O). Ketones where n ranges between 1 and 4 are optimal for usage as a lottery scratch-off game solvent. Examples include acetone (C3H6O), where n=1 for R1 and n=1 for R2, and methylethyl ketone (C4H8O), where n=1 for R1 and n=2 for R2. Acetone and methylethyl ketone are useful for reducing drying times in scratch-off coating removal and exhibit excellent solvency performance when combined with short-chain alcohols or glycol ethers. Aldehydes are fragrant and potent compounds which conform to the structure (R1-(C═O)—H), where R1 is an alkyl chain conforming to (CnH2n+1), or substituted chains. These chains are covalently bonded to the carbonyl or adehyde function ((C═O)—H) in the terminal position. Examples include valeraldehyde (C5H10O), where n=5.

Certain polar organic solvents possess a carbon-carbon double bond. These compounds typically fall into a group called “alkenes”. The carbon-carbon double bond, or “C═C” may take its position anywhere within a particular compound, varying the degree of solvent power. Other functional groups may accompany the carbon-carbon group, such as the carbonyl function. An example of such a combination which is also highly effective for opaque coating removal is mesityl oxide, also known as 4-methyl-3-penten-2-one. In this compound a carbonyl function in the second position accompanies the carbon-carbon double bond in the third position. Ether linkages may also accompany the alkene. An example is ketene diethyl acetal, also known as 1,1-diethoxyethene, where two ethyl groups are ether linked to the ethene alkene.

Any single molecule or combination of the molecules discussed above typically possesses low viscosity, and thus are water-like in flow. When dispensing the solvent, flow control is needed to prevent excess solvent from freely flowing and thereby from damaging surfaces beneath the lottery ticket, such as countertops or tabletops. One method to increase flow control is by increasing viscosity. Certain thickening agents can be dispersed within polar solvents, thereby changing their Theological properties. These Theological modifiers include, but are not limited to, hydroxylated alkyl celluloses, such as hydroxypropylcellulose, and methyl hydroxy propylcellulose. These compounds are collectively known as Methocel, a common cosmetic incipient manufactured by Dow Chemical.

Colorants, fragrances, and cosmetic ingredients can be added to a formulation containing the molecules described above. Since the molecule or combination of molecules exhibit such strong solvency, fragrance oils and dyes are readily dissolved, dispersed, or solvated into the formulation. Most colorants, fragrances, and cosmetic ingredients are utilized at a relatively small percentage in the formulation when compared to the overall percentage of solvents used. Thus, solvent efficacy is not sacrificed by making the chemical solvent aesthetically pleasing.

A container which is not weakened or damaged by these strong solvents is necessary to hold the solution indefinitely. Glass may be utilized with a high degree of success. Dense plastics, such as high density polyethylene (HDPE), are also compatible with most short-chain alcohols, ketones, ethers, and glycol ethers, and glycol ether acetates. The container must impede evaporation losses of the solvent to the atmosphere when stored and therefore must not be porous.

### BRIEF DESCRIPTION OF THE DRAWINGS

FIG. 1 illustrates the general chemical structure of a glycol ether which is used to remove the opaque coating but not the printed indicia of a scratch-off lottery or game ticket.

FIG. 2 details the general chemical structure of a polar organic solvent containing a carbon-hydroxyl or alcohol function which is used to remove the opaque coating but not the printed indicia of a scratch-off lottery or game ticket.

FIG. 3 describes the general chemical structure of a polar organic solvent containing a carbonyl function which is used to remove the opaque coating but not the printed indicia of a scratch-off lottery or game ticket.

FIG. 4 illustrates the general chemical structure of a glycol ether acetate which is used to remove the opaque coating but not the printed indicia of a scratch-off lottery or game ticket.

FIG. 5 illustrates the general chemical structure of a polar organic solvent containing a carbon-carbon double bond which is used to remove the opaque coating but not the printed indicia of a scratch-off lottery or game ticket.

FIG. 6 details the chemical structure of the glycol ether diethylene glycol monoethyl ether.

FIG. 7 details the chemical structure of the ketone acetone.

FIG. 8 details the chemical structure of the aldehyde valeraldehyde.

FIG. 9 details the chemical structure of the alcohol ethanol.

FIG. 10 details the chemical structure of mesityl oxide, an alkene containing a carbonyl.

FIG. 11 details the chemical structure of ketene diethyl acetal, an alkene containing ether linkages.

FIG. 12 details the chemical structure of the carbonyl 2-pyrrolidinone.

FIG. 13 provides a chemical solvent formulation using two glycol ethers.

FIG. 14 describes a chemical solvent formulation using one glycol ether and one other polar solvent.

FIG. 15 illustrates a chemical solvent formulation using one glycol ether and a multitude of polar solvents.

FIG. 16 illustrates a chemical solvent formulation using many polar organic solvents.

### DESCRIPTION OF THE PREFERRED EMBODIMENTS

The preferred embodiments of the invention described herein are exemplary and numerous modifications, dimensional variations, and rearrangements can be readily envisioned to achieve an equivalent result, all of which are intended to be embraced within the scope of the appended claims.

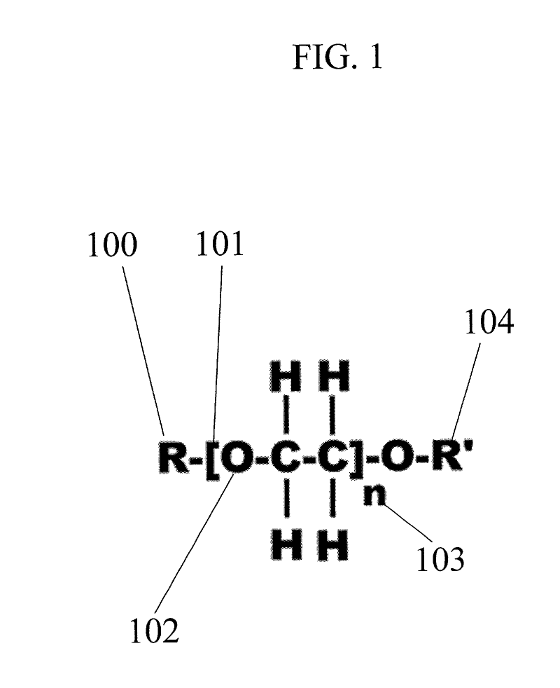

FIG. 1 illustrates the general chemical structure of a glycol ether which is used to remove the opaque coating but not the printed indicia of a scratch-off lottery or game ticket. The glycol ether is comprised of a first group “R” (100). R is an alkyl group containing between one and seven alkyl carbon atoms, a phenyl group, or an alkyl substituted phenyl. An ethoxy group (102) is ether-linked (102) to “R”. The ethoxy group is repeated “n” times (103), where n is equal to 1, 2, or 3. The terminal functional group (104) “R′” consists of one of the following: hydrogen; between one and seven alkyl carbon atoms; a carboxylic acid ester; sulfate; phosphate; nitrate; and sulfonate.

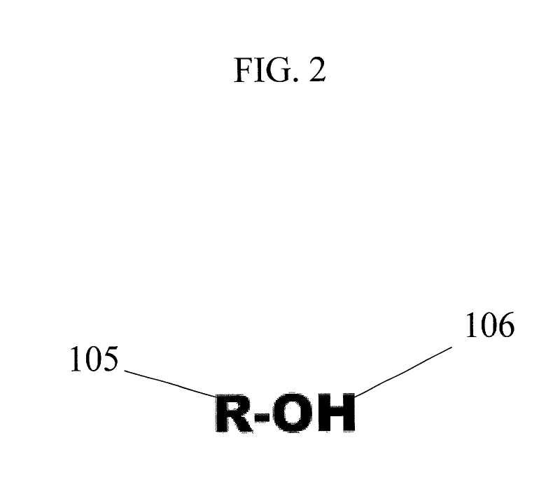

FIG. 2 details the general chemical structure of a polar organic solvent containing a carbon-hydroxyl or alcohol function which is used to remove the opaque coating but not the printed indicia of a scratch-off lottery or game ticket. An alkyl carbon group (105) “R” is covalently bonded to a hydroxyl function (106) “OH”. “R” contains between one and four carbon atoms in a linear or branched arrangement.

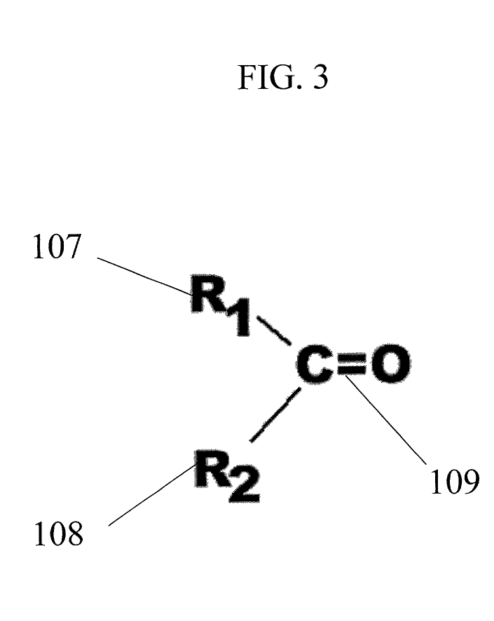

FIG. 3 describes the general chemical structure of a polar organic solvent containing a carbonyl function which is used to remove the opaque coating but not the printed indicia of a scratch-off lottery or game ticket. A first alkyl group (107) “R1” is covalently bonded to a carbonyl function (109). “R1” contains between one and four carbon atoms. Similarly, a second alkyl group (108) “R2” is also covalently bonded to the carbonyl function. “R2” contains hydrogen, or between one and four carbon atoms. If “R2” contains only hydrogen, or “H”, the structure is an aldehyde.

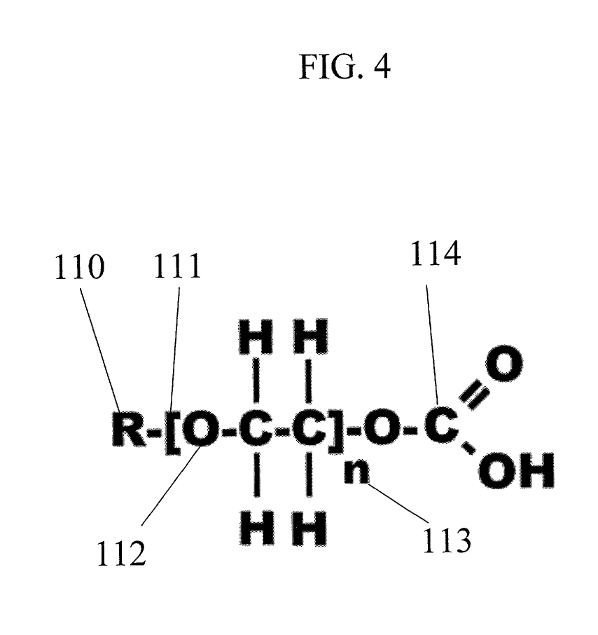

FIG. 4 illustrates the general chemical structure of a glycol ether acetate which is used in combination with a glycol ether in order to remove the opaque coating but not the printed indicia of a scratch-off lottery or game ticket. The glycol ether acetate is comprised of a first group “R” (110). R is an alkyl group containing between one and seven alkyl carbon atoms, a phenyl group, or an alkyl substituted phenyl. An ethoxy group (111) is ether-linked (112) to “R”. The ethoxy group is repeated “n” times (113), where n is equal to 1, 2, or 3. The terminal functional group (114) “R′” consists of the carboxylic acid. Because the carboxylic acid has an ether linkage to the repeating ethoxy groups, it is called an ester. In this figure, the ester (114) is termed an “acetate” because it contains a single carbon atom. Thus, the complete structure represents a glycol ether acetate.

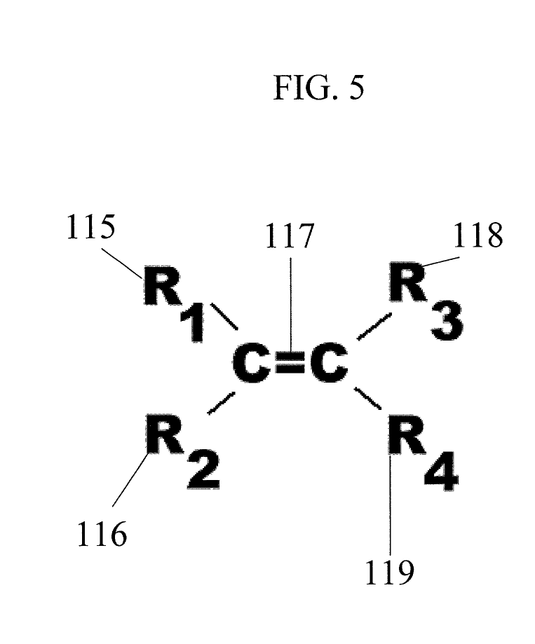

FIG. 5 illustrates the general chemical structure of a polar organic solvent containing a carbon-carbon double bond which is used to remove the opaque coating but not the printed indicia of a scratch-off lottery or game ticket. An alkyl or substituted group, “R1” (115), is covalently bonded to the carbon-carbon double bond function, or alkene (117). Similarly, another alkyl or substituted group, “R3” (118), is covalently bonded to the alkene. The groups “R2” (116) and “R4” (119) are either hydrogen atoms, or additional alkyl or substituted groups.

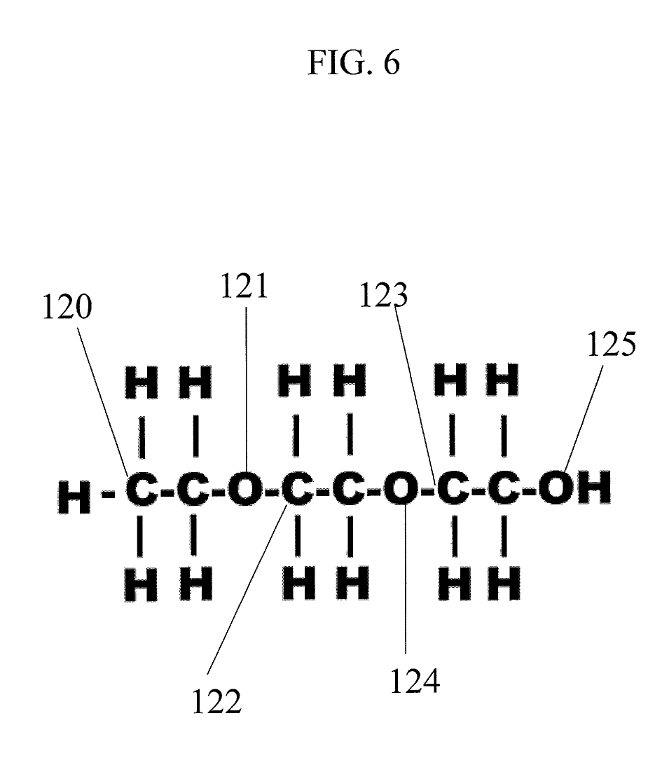

FIG. 6 details the chemical structure of diethylene glycol monoethyl ether. The structure of diethylene glycol monoethyl ether begins with a two alkyl carbon group (120), ether linked (121) to a second two alkyl carbon group (122), which is ether-linked (124) to an ethanol group (123). The ethanol group contains the terminal hydroxyl function (125). Since the ether linkage occurs at the second carbon of each alkyl carbon group, the group is called a “2-ethoxy” group. Overall, the structure can be read as 2-(2-ethoxyethoxy)ethanol. Diethylene glycol monoethyl ether, or 2-(2-ethoxyethoxy)ethanol, gains its excellent solvency powers from both its ether and hydroxyl functional groups. A total of six carbon atoms exist in this compound.

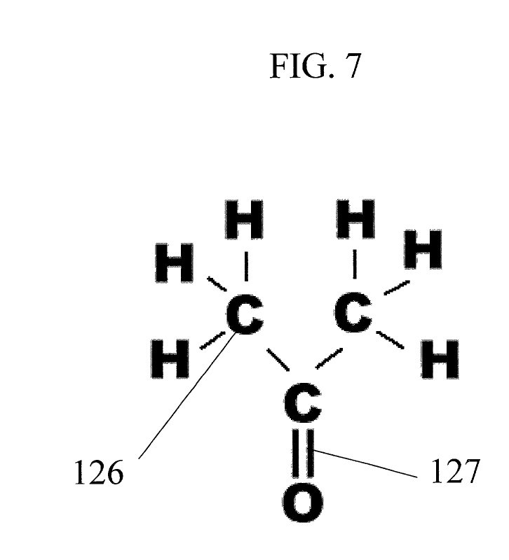

FIG. 7 details the chemical structure of the ketone acetone. Two methyl groups (126) are covalently bonded to the carbonyl function (127), giving dimethyl ketone or acetone. A total of three carbons exists with one carbonyl function present.

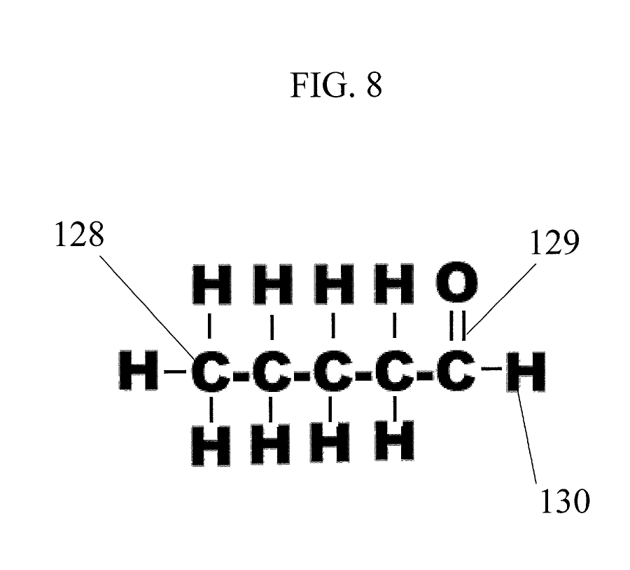

FIG. 8 details the chemical structure of the aldehyde valeraldehyde. A carbonyl group (129) is present in the first position of a linear pentane group (128). Since a terminal hydrogen is present (130), this is an aldehyde rather than a ketone. Valeraldehyde possess a total of five carbons along with one carbonyl functional group.

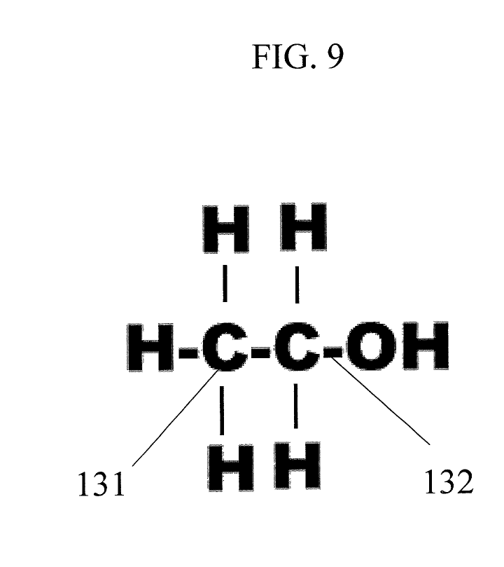

FIG. 9 details the chemical structure of the alcohol ethanol. A hydroxyl function is bonded (132) to an ethane alkyl group, producing ethyl alcohol, or ethanol. A total of two carbon atoms exists with one carbon-hydroxyl functional group.

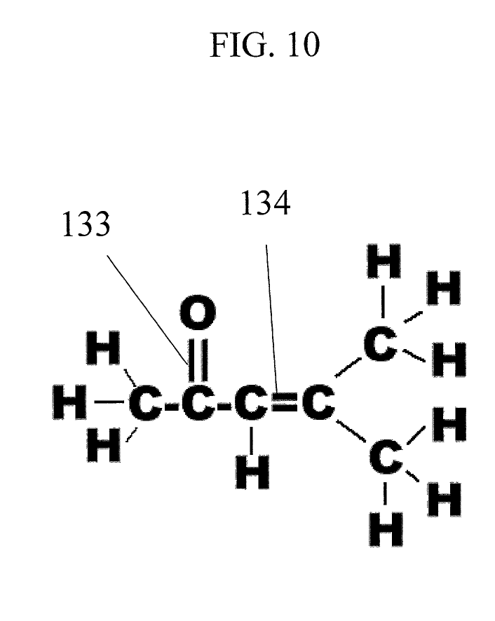

FIG. 10 details the chemical structure of mesityl oxide, an alkene containing a carbonyl. This structure can be viewed as a pentane chain. Right to left, a carbonyl group (133) is present in the second position of overall chain. The alkene, or carbon-carbon double bond function (134), exists at the third position of the overall chain. The structure is then read as 4-methyl-3-penten-2-one. The carbonyl and alkene groups make this compound particularly useful, since it is a strong solvent, dries quickly, and has a pleasant odor. A total of six carbon atoms exist with one carbon-carbon double bond functional group and one carbonyl functional group.

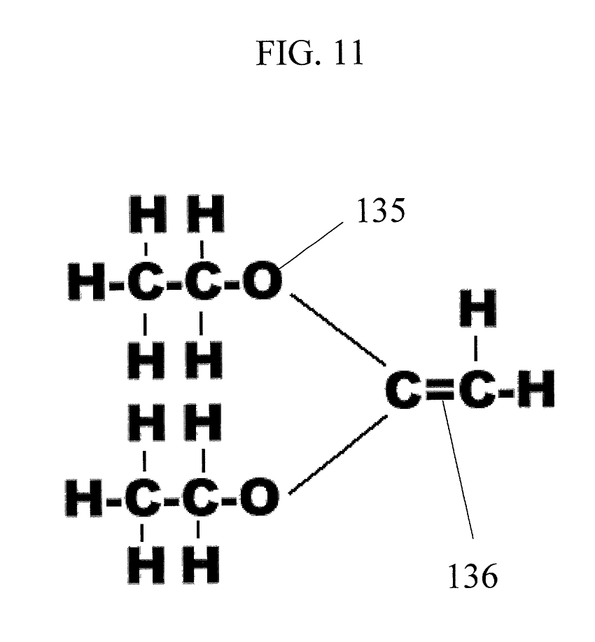

FIG. 11 details the chemical structure of ketene diethyl acetal, an alkene containing ether linkages. Two ethane alkyl groups are ether-linked (135) to the ethene alkene group, which possesses the carbon-carbon double bond (136). Overall, the structure is read as 1,1-diethoxyethene. This compound is a good solvent and dries quickly. A total of six carbon atoms exist with one carbon-carbon double bond function.

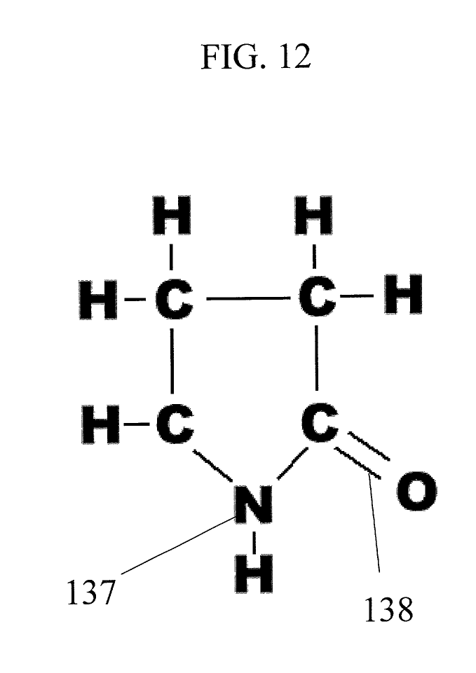

FIG. 12 details the chemical structure of the carbonyl 2-pyrrolidinone. Built upon a cyclic ring, a nitrogen atom is present (137). The carbonyl functional group is present at the second position of the ring (138). This compound has a higher viscosity than ketones and possesses moderate solvent properties. Overall, there are four total carbon atoms with one carbonyl functional group.

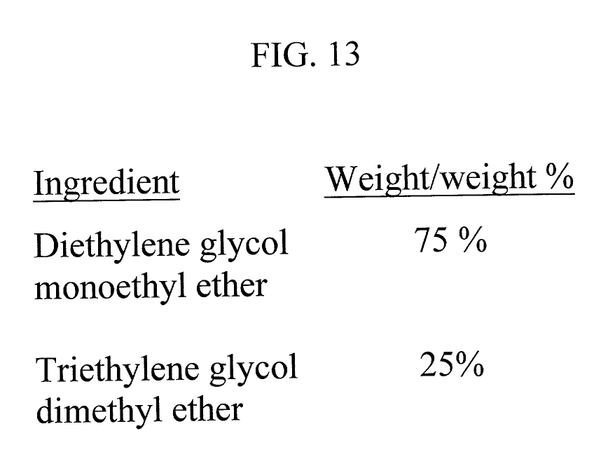

FIG. 13 provides a chemical solvent formulation using two glycol ethers. In this formulation, diethylene glycol monoethyl ether, the primary solvent, is combined with triethylene glycol dimethyl ether. This particular formulation is useful for very thick opaque coatings which require high solvency power. Only a small amount of this formulation is needed to remove an opaque scratch-off coating, however, this formulation has a very long drying time. Excess solvent is usually wiped off of the exposed ticket with a cloth.

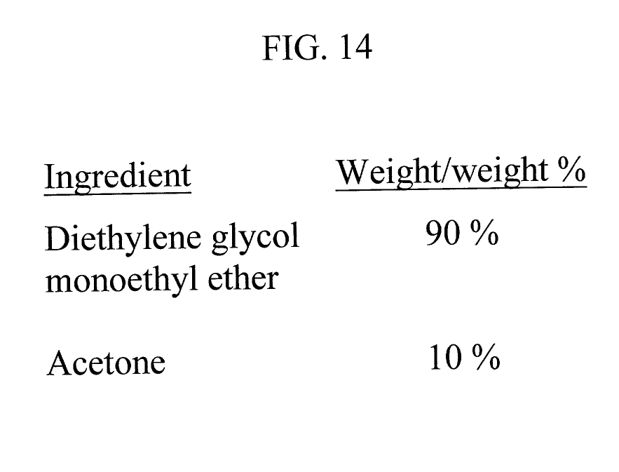

FIG. 14 describes a chemical solvent formulation using one glycol ether and one polar organic solvent. In this formulation, diethylene glycol monoethyl ether is the primary solvent, taking up 90% of the entire weight of the formula. Acetone, or dimethyl ketone, is a polar solvent comprised of three carbon atoms. The acetone aids to decrease the drying time of the solvent. The acetone is kept at a relatively small percentage, 10%, in the formula because of its flammability and volatility.

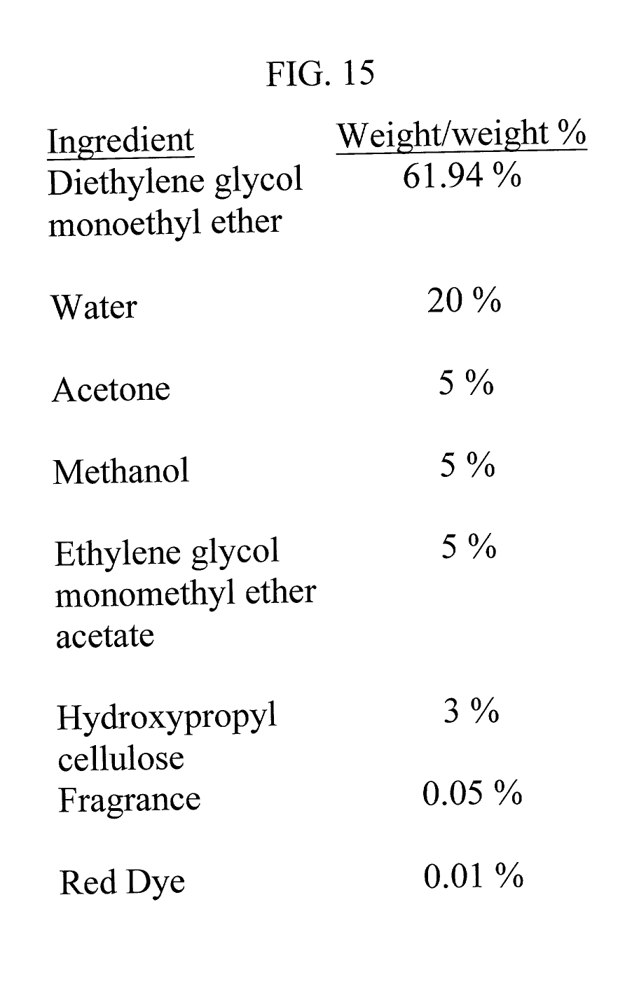

FIG. 15 illustrates a chemical solvent formulation using one glycol ether and a multitude of polar solvents. This particular formulation is a cosmetically appealing solvent used for thin scratch-off coatings on lottery and game tickets. The solvency power of the primary solvent, diethylene glycol monoethyl ether, is diluted using water, a polar solvent. A three carbon ketone, acetone, is added to reduce drying time. A single carbon alcohol, methanol, is also added to reduce drying time. A small amount of glycol ether acetate, ethylene glycol monomethyl ether acetate, is added to aid the primary solvent in coating removal. Hydroxypropyl cellulose is a rheological modifier which is dispersed throughout the formulation. Hydroxypropyl cellulose increases the viscosity of the formulation, allowing the solvent to be applied in a controlled manner onto the scratch-off lottery or game ticket. Finally, a very small amount of fragrance and red dye is added for cosmetic appeal. Enough solvency power exists in the formulation to incorporate the fragrance and dye without loss of efficacy.

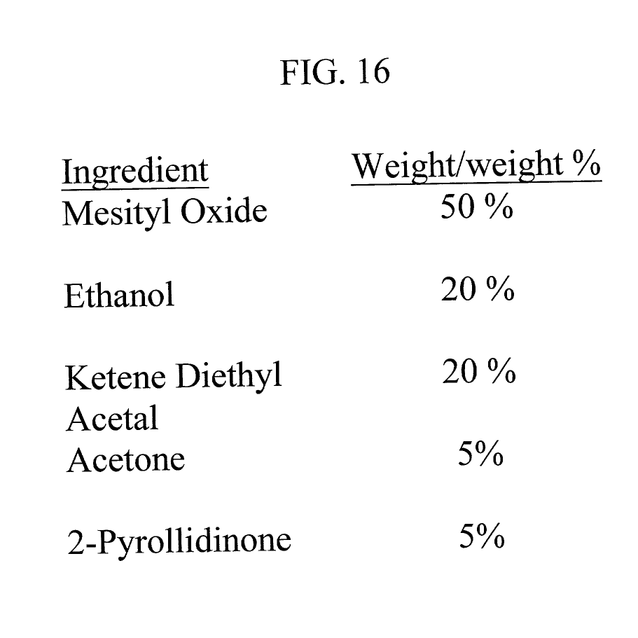

FIG. 16 illustrates a chemical solvent formulation using many polar organic solvents. Mesityl oxide is the primary solvent, dissolving most of the opaque coating upon contact. The ketene diethyl acetal further weakens the liquefied opaque coating. Ethanol and acetone are added to the formula to decrease the drying time of the solvent, so that the liquefied coating does not flow onto the user's hand or table tops. The 2-pyrollidinone is added to give a slight increase in viscosity while not subtracting any solvent power. Only a very small amount of this particular formulation, on the order of one milliliter, is needed to effectively expose a scratch-off game ticket quickly.

### Industrial Application

This invention finds application in governmental and private gambling industries.

I claim:

1. A chemical solvent comprised of 100% by weight of a glycol ether which removes the scratch-off coating but not the printed indicia beneath the scratch-off coating once applied to a scratch-off game ticket or lottery ticket.

2. Said glycol ether in claim 1 contains a total of at least three carbon atoms.

3. Said glycol ether in claim 1 is diethylene glycol monoethyl ether.

4. A polar organic solvent containing between one and nine total carbon atoms and containing a functional group which is one of a carbonyl, carbon-hydroxyl, carbon-carbon double bond, and carboxylic acid group, which also removes the scratch-off coating but not the printed indicia beneath the scratch-off coating once applied to a scratch-off game ticket or lottery ticket.

5. Said polar organic solvent containing a carbonyl functional group in claim 4 is one of valeraldehyde, methylethyl ketone, acetone, and 2-pyrrolidinone.

6. Said polar organic solvent containing a carbon-hydroxyl functional group in claim 4 is one of methanol, ethanol, isopropanol, and a glycol ether.

7. Said polar organic solvent containing a carbon-carbon double bond functional group in claim 4 is one of ketene diethyl acetal and mesityl oxide.

8. Said polar organic solvent containing a carboxylic acid functional group in claim 4 is ethylene glycol monomethyl ether acetate.

9. A chemical solvent comprised of one glycol ether and at least one polar organic solvent which removes the scratch-off coating but not the printed indicia beneath the scratch-off coating once applied to a scratch-off game ticket or lottery ticket.

10. Said glycol ether in claim 9 is contains a total of at least three carbon atoms.

11. Said polar organic solvent in claim 9 contains between one and nine carbon atoms.

12. Said polar organic solvent in claim 9 contains a functional group which is one of a carbonyl, carbon-hydroxyl, carbon-carbon double bond, and carboxylic acid.
